(19) United States
(12) Patent Application Publication
(10) Pub. No.: US 2002/0001277 A1
(43) Pub. Date: Jan. 3, 2002

(54) Method for encoding and recording non-audio data on a compact disc

(76) Inventor: Keith E. Thomas, Jacksonville, IL (US)

Correspondence Address: LYON & LYON LLP, 633 WEST FIFTH STREET, SUITE 4700, LOS ANGELES, CA, 90071, US

(21) Appl. No.: 09/821,728

(22) Filed: Mar. 28, 2001

Related U.S. Application Data
(60) Provisional application No. 60/192,502, filed on Mar. 28, 2000.

(51) Int. Cl. G11B 7/0045

(52) U.S. Cl. 369/59.21; 369/59.25; 369/59.24

(57) ABSTRACT

A method for encoding and recording non-audio data on a compact disc medium. The non-audio data is encoded as a non-audio data track having an audio format compatible with a standard format which calls for digital audio encoding utilizing a predefined number of bits per sample. The non-audio data is encoded using less than the predefined number of bits per sample, and preferably no more than one-half the predefined number of bits per sample. The non-audio data is preferably encoded such that the audio signal resulting from the non-audio data track is substantially equally distributed across an audible spectrum and is an approximation of white noise. The non-audio data track, once encoded, is recorded along with a plurality of audio tracks on the compact disc. Additional non-audio data may be encoded as a watermark within the non-audio data track. A compact disc recorded thusly is compatible with existing CD players.

This application claims the benefit of U.S. Provisional Application No. 60/192502, filed on Mar. 28, 2000.

### BACKGROUND OF THE INVENTION

1. Field of the Invention

The present invention relates generally to the field of digital audio reproduction. In particular, the present invention relates to the encoding and recording of non-audio data on a compact disc medium containing digital audio.

2. Background of the Invention

Standard audio tracks are recorded on a compact disc (CD) medium using eight to fourteen modulation (“EFM”), the characteristics of which are well known to those skilled in the art and are described in standards known as the “Compact Disc Digital Audio System Description,” otherwise known as the Red Book standard promulgated by Philips, and the “Compact Disc Digital Audio System,” otherwise known as IEC 60908. The Red Book standard is considered by many skilled in the art to be the industry standard, however, the IEC 60908 standard closely approximates and is substantially similar to the Red Book standard. Both standards are herein incorporated herein by reference. These standards define the format for Compact Disc Digital Audio, including the physical, logical, and content description details. A CD player reads the digital audio data recorded on a CD and reproduces the audio signal represented by the digital audio data by using information provided by the Red Book standard.

In recent years, several other CD audio standard formats have been developed to address the limitations of the original Red Book standard. Many of these standard formats are enhancements of the standard Red Book audio format and allow CDs to hold other types of digital data, including alphanumeric data, video, and graphics. These formats can be used to store text information such as an artist's name, the album and song titles, and the song lyrics.

Read Only Memory (ROM) CDs, commonly known as CD-ROMs, are recorded according to a different standard format, known as the Yellow Book. The Yellow Book standard is similar to the Red Book standard, but includes additional error detection and correction to ensure that data is not lost due to disc surface scratches. Yet another standard, known as the Blue Book, also commonly referred to as “CD Plus”, “Stamped Multisession”, or just “Multisession”, enables two or more sessions to be recorded on the same compact disc medium. Each session on a Multisession CD may be recorded using a different standard. For example, on a Multisession CD having two sessions, the first session may include audio recorded according to the Red Book standard and the second session may include non-audio data recorded according to the Yellow Book standard.

There are significant disadvantages to the Multisession format, from both a production as well as a consumer standpoint. Multisession CDs combine both audio and data content, making them more difficult and expensive to produce than CDs that contain digital audio only. The production difficulty arises primarily because existing CD replicators are not equipped to mass produce Multisession CDs. Moreover, because the Multisession standard is not yet well established in the consumer realm and not fully compatible with either the Red Book or Yellow Book standards, many existing CD-ROM drives and CD audio components are not capable of playing Multisession CDs.

Multisession CD's also require a physical gap on the CD medium to separate the content recorded in the different sessions. This gap typically amounts to approximately 2.5 minutes of audio storage space, or nearly 3% of the total CD capacity. This 2.5 minutes of space may not be used to store data, digital audio data or otherwise. Use of Multisession CDs to facilitate the display of text, which may be used, for example, to show song titles and lyrics, also requires additional hardware in the CD player to support access to the non-audio data representing the text. In order to read a Multisession CD, a CD player must be able to read the non-audio data content in addition to digital audio content. Such dual capability adds to the expense of manufacturing the CD player hardware. Currently, the Multisession standard is not supported by any manufacturer of CD audio players and therefore has not found a niche in the consumer audio market.

Another standard format, referred to as CD Text, is an extension of the Red Book standard. It provides the ability to include non-audio data along with the audio tracks. CD Text encodes non-audio data into a subcode channel that is unused under the Red Book standard. Hence, a CD encoded using the CD Text standard is compatible with CD players designed around the Red Book standard. The non-audio data in the subcode may provide information such as track title and artist. Several different implementations of CD players exist which can access the non-audio data encoded using the CD Text standard. Such CD players typically provide a range of displays between 1 and 21 lines of 40 color characters. Small bitmapped logos may also be encoded in the subcode. However, most CD Text compatible CD players do not typically display graphics. The CD Text standard also calls for CD players to display a menu listing the available non-audio data items.

The CD Text standard also has some disadvantages. One disadvantage is that the CD Text standard limits the non-audio data to small bitmaps and text which is contained in a predefined character table. In addition, the storage space available for encoding the non-audio data is limited by the size of the subcode channel, allowing for at most 20 megabytes of data. Another disadvantage to storing non-audio data in the subcode channel is that it is interleaved with the main digital audio data, thus requiring different coding and error correction methods. Therefore, the non-audio data must be interpreted separately by the CD player hardware for control purposes. As a result, the non-audio data in the subcode channel cannot be reliably retrieved from many CD-ROM drives.

Based on the foregoing, a need exists for an improved method of storing non-audio data (e.g. text, digital, numeric, binary, graphic) on digital audio CDs. Such a method would preferably allow the non-audio data to be stored alongside the digital audio content on a CD while maintaining compatibility with existing CD players. Additionally, the method would preferably store the non-audio data in a manner that does not modify the sound quality or significantly reduce the storage capacity of the CD.

Copy Protection of Digital Audio Content

As digital audio technology has progressed, CD player components and home computers have been developed which are capable of encoding and recording digital audio CD's. When the digital audio CD was first designed, copyright protection was not an issue. At the outset, the threat of consumers making their own audio CD's was remote in light of the complexity and costs required to create digital audio CD's. With the rapid advances in technology, consumers may now easily acquire the capability to inexpensively copy digital audio CD's with a CD component player or CD-ROM drive connected to a standard personal computer. These consumer products are capable of making exact replicas of the digital audio content contained on a digital audio CD, with no limit to the number of replicas created. Therefore, with the proliferation of such consumer products, a need to provide some additional measure of copyright protection for digital audio content has emerged.

Accordingly, copyright holders require a cost effective way to produce digital audio CDs with some guarantee of protection to deter copying. Standard digital audio CDs can be easily “ripped.” In other words, the digital audio content can be copied bit for bit with a standard home computer and then stored on a recordable CD, all without knowledge or consent of the copyright holder.

Several ideas to address the issue of copyright protection have recently emerged. The use of an audio “watermark” is one such idea. With a watermark, information about the artist and the tracks on the CD may be encoded within the audio. Unlicensed copies are detected by decoding the watermark in an audio sample. However, a watermark does not necessarily prevent unlicensed copying. Watermarking may be easily defeated through clever disguising algorithms because the watermark is embedded in the audio signal. Modification of the audio signal may allow individuals to defeat the watermarking by hiding or otherwise disguising the watermark. Watermarking also suffers another disadvantage because it is passive in nature. Rather than deterring the making of an unlicensed copy, a watermark serves only to identify the copyright holder after the copy has been made. Furthermore, a watermark can only provide a limited amount of information because it is encoded in the music. Even when the amount of information encoded is small, the quality of the audio suffers to some extent. The more information encoded, the greater the degradation in the audio quality.

A need therefore exists for an improved method allowing a copyright holder to protect copyrighted music from unlicensed reproduction, while still allowing the consumer use of high quality digital audio. The solution, therefore, should not degrade the quality of the audio on the CD.

### SUMMARY OF THE INVENTION

The present invention presents an improved method for encoding and recording non-audio data on a digital audio compact disc (CD) medium. The non-audio data may comprise many different types of non-audio data such as, for example, text, graphics, logos, hyperlinks to web sites, and data used for identification or copyright protection purposes. The non-audio data may include such information as an artists name, the title of a CD, the number of tracks on the CD, the title of the tracks on the CD, the running time of each track, the overall running time of the CD, etc.

The non-audio data is encoded as a non-audio data track having an audio format compatible with a standard format, wherein the standard format calls for digital audio encoding utilizing a predefined number of bits per sample. The non-audio data is encoded using less than the predefined number of bits per sample so that the audio signal resulting from the non-audio data track has an amplitude that is less than the maximum amplitude available using the standard format. Once the non-audio data is encoded as the non-audio data track, the non-audio data track and a plurality of audio tracks are recorded onto the CD medium according to the standard format. When the non-audio data is encoded and recorded in this manner, the resulting CD is fully compatible with existing CD player technology.

Accordingly, in a first separate aspect of the invention, non-audio data is encoded as a non-audio data track having an audio format that is compatible with a standard format. The non-audio data is encoded using fewer than the predefined number of bits per sample called for in the standard format. The non-audio data track and a plurality of digital audio tracks are recorded on a CD medium in accordance with the standard format.

In a second separate aspect of the invention, the standard format used to record the non-audio data track on the CD medium is the Red Book standard which is commonly known to those skilled in the art.

In a third separate aspect of the invention, the non-audio data may comprise encrypted data.

In a fourth separate aspect of the invention, the non-audio data is encoded using no more than one-half the predefined number of bits per sample called for in the standard format.

In a fifth separate aspect of the invention, the non-audio data track represents an audio signal that is substantially equally distributed across an audio spectrum. In the preferred embodiment, the audio spectrum ranges approximately between 20 Hz and 20 kHz.

In a sixth separate aspect of the invention, the non-audio data is combined with a pseudo random sequence to generate a data sequence. The data sequence is encoded as the non-audio data track. By encoding the non-audio data in this manner, the audio signal representing the non-audio data track may be shaped to any desired audio spectrum. The non-audio data track is recorded, together with a plurality of digital audio tracks, on the CD medium.

In a seventh separate aspect of the invention, the non-audio data track may be incorporated into one of the plurality of digital audio tracks. The digital audio tracks, including the digital audio track with the incorporated the non-audio data track , are recorded onto the CD medium. Preferably, if the non-audio data track is incorporated at the end of a digital audio track, that digital audio track is recorded as the last track on the CD. Likewise, if the non-audio data track is incorporated at the beginning of a digital audio track, that digital audio track is recorded as the first track on the CD.

In an eighth separate aspect of the invention, the non-audio data comprises first data and second data. The first data may be encoded as the non-audio data track or combined with a pseudo random sequence to create a data sequence, the data sequence then being encoded as the non-audio data track. The second data is encoded as a watermark within the non-audio data track using methods and techniques that are commonly known to those skilled in the art. The non-audio data track, comprising both the first and second data, and a plurality of digital audio tracks are thereafter recorded on the CD.

In a ninth separate aspect of the invention, the method of encoding and recording non-audio data on a CD, as described herein, may be used as part of a copy protection scheme by copyright holders to prevent unwanted or illegal copying of the digitally recorded audio on the CD.

In a tenth separate aspect of the invention, non-audio data may be stored on a digital audio CD using the method described herein without losing significant storage space on the CD medium and without losing or reducing the quality of the digital audio encoded on the CD.

In an eleventh separate aspect of the invention, a CD recorded using the method as described herein is fully compatible with existing CD players.

In a twelfth separate aspect of the invention, existing CD manufacturing equipment and software may be used to manufacture CDs using the method as described herein with little or no modifications, thereby providing an inexpensive means to encode and record non-audio data on a CD medium.

### BRIEF DESCRIPTION OF THE DRAWINGS

In the figures, wherein like numbers reflect similar elements:

FIG. 1a illustrates a non-audio data encoding scheme using less than 16 bits per sample;

FIG. 1b illustrates the dynamic range of the scheme shown in FIG. 1a as compared to audio encoded at 16 bits per sample;

FIG. 1c illustrates a compact disc on which a track encoded with the scheme of FIG. 1a is recorded;

FIG. 1d is an illustration of a basic system and process for reading and using the encoded schemes;

FIG. 2a illustrates a non-audio data encoding scheme using 8 bits per sample;

FIG. 2b illustrates the dynamic range of the scheme shown in FIG. 2a as compared to audio encoded at 16 bits per sample;

FIG. 3a illustrates schematically audio tracks recorded on a CD using the Red Book digital audio standard according to the prior art;

FIG. 3b illustrates schematically a first method of recording non-audio data on a CD using the Red Book digital audio standard;

FIG. 3c illustrates schematically a second method of recording non-audio data on a CD using the Red Book digital audio standard.

### DETAILED DESCRIPTION OF THE PREFERRED EMBODIMENTS

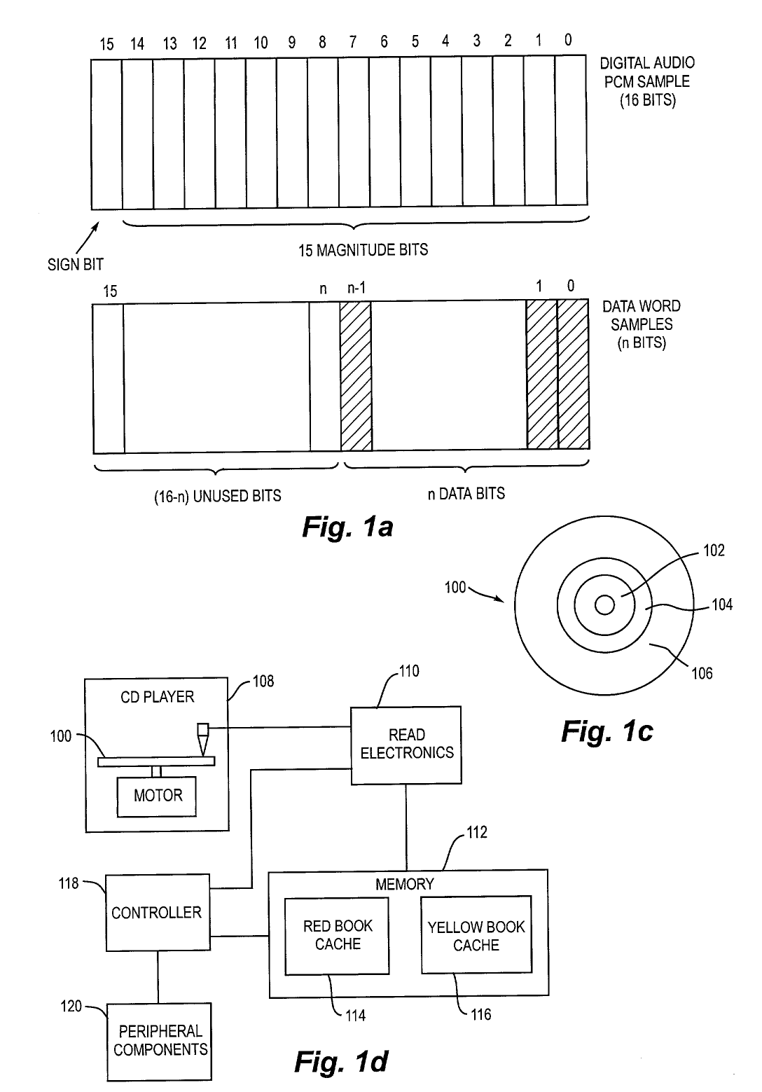

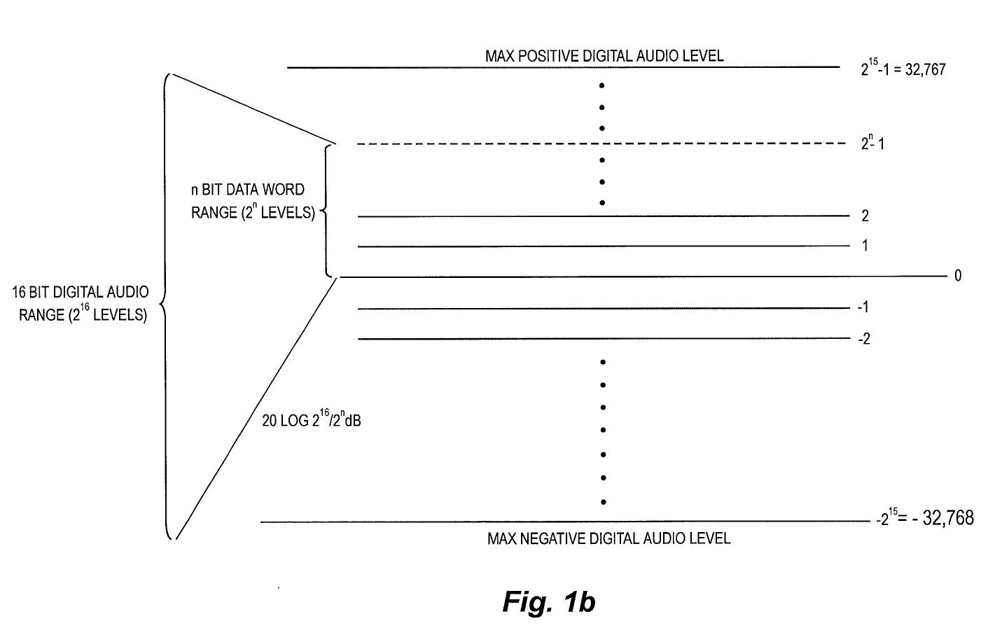

Turning now to the drawings, FIG. 1a illustrates a scheme of encoding non-audio data in an audio format that may be recorded on a compact disc medium. Many types of non-audio data may be used, such as, for example, artist information, album and song titles, hyperlinks to web sites, publisher information, logos, graphics, and data that may be used in copy protection schemes implemented using the method described herein. Additionally, any such data may be encrypted for further protection.

The non-audio data is encoded as a non-audio data track having an audio format that is compatible with a standard format used by industry for recording audio on a CD such as, for example, the IEC 60908 standard format, the Red Book standard format, or any other standard format, so long as the standard predefines the number of bits used per sample. The Red Book standard of digital audio predefines the digital audio format to have 16 bits per sample at a 44.1 kHz sample rate per stereo channel to represent the dynamic range of the amplitude from an analog audio signal. The amplitude of one channel (left or right) of the analog audio signal is therefore represented by a 16 bit two's complement representation. A single sample, also called a data word, is illustrated in FIG. 1a. The last bit of the data word is reserved for the sign (positive or negative) of the amplitude and the first fifteen bits represent the amplitude of the analog audio signal. Using a 16 bit data word, a wide range of discrete amplitudes, ranging from +32,767 to −32,768, may be stored digitally. Expressed in terms of decibels, the Red Book standard provides a total dynamic range (ratio of maximum signal amplitude to minimum signal amplitude) of 96 dB (=20*log(2¹⁶)).

When an analog signal is encoded as digital audio using less than the full 16 bit range available under the Red Book standard, then the audio signal resulting from the digitally encoded audio will have a dynamic range of less than 96 dB. For example, an analog audio signal digitized using n bits per sample, where n<16, results in a discrete amplitude range of −2ⁿ⁻¹ to +2ⁿ⁻¹−1. The maximum dynamic range of such a digitized signal is 20*log(2ⁿ) dB, or 20*log(2^{16/}2ⁿ) dB less than the maximum dynamic range available using the Red Book standard.

The non-audio data track is provided with an audio format by allocating the non-audio data into a series of 16 bit data words. The amount of non-audio data that may be stored in the data words at the 44.1 kHz sample rate, assuming the full 16 bit data word is utilized for storage on a stereo channel, is approximately 176,400 bytes per second. A ten second non-audio data track at this rate is therefore capable of containing approximately 1,764,000 bytes of non-audio data.

In the preferred embodiment, the non-audio data is encoded using fewer bits than available in the predefined data word. For example, using the Red Book standard, the non-audio data is converted into a series of data words, each data word being less than 16 bits in length. The remaining unused bit(s) in each data word, up to bit 15, are assigned a zero value. Referring to FIG. 1a, the non-audio data is placed in the first n bits of the 16 bit data word, where n<16. The unused bits in the data word, i.e., those bits between bit n and bit 15 inclusive, have a zero value. The non-audio data track is therefore comprised of a series of 16 bit data words, each data word effectively being an n bit data word. The non-audio data track thus described results in an audio signal having a peak audio level of 20*log(2^{16/}2ⁿ) dB less than the peak audio level available using the entire 16 bits of the data word.

FIG. 1b provides a general illustration of the dynamic range difference between the 16 bit digital audio signal and a non-audio data track which uses n bits per data word to store the non-audio data, where n<16. The audio signal resulting from the non-audio data track would be interpreted by an audio CD player at an amplitude level of 20*log(2^{16/}2ⁿ) dB lower than the peak digital audio sample amplitude. Therefore, by reducing the number of bits in the 16 bit data word in which the non-audio data is stored, the audibility of the non-audio data track may be decreased. In the preferred embodiment, the non-audio data is stored using no more than one-half the bits available in a data word. Thus, the non-audio data, when encoded as a non-audio data track to be compatible with the Red Book standard, is stored in no more than 8 bits of the 16 bit data word. The audio signal resulting from such a non-audio data track will be less audible because its peak audio level will be 48 dB less than the peak audio level available using the Red Book standard. The amount of non-audio data that may be stored in a one second long non-audio data track having an effective 8 bit data word and using both stereo channels is approximately 88,200 bytes. In the preferred embodiment the non-audio data is encoded using no more than 8 bits of the 16 bit data word.

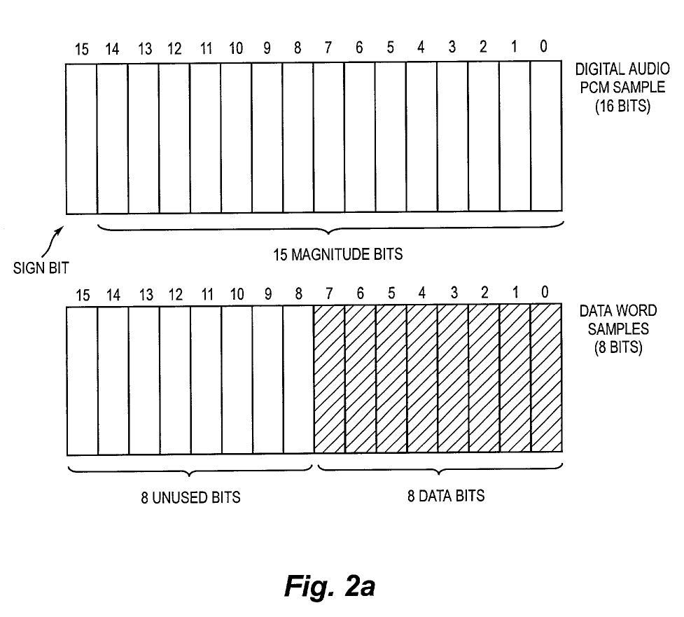

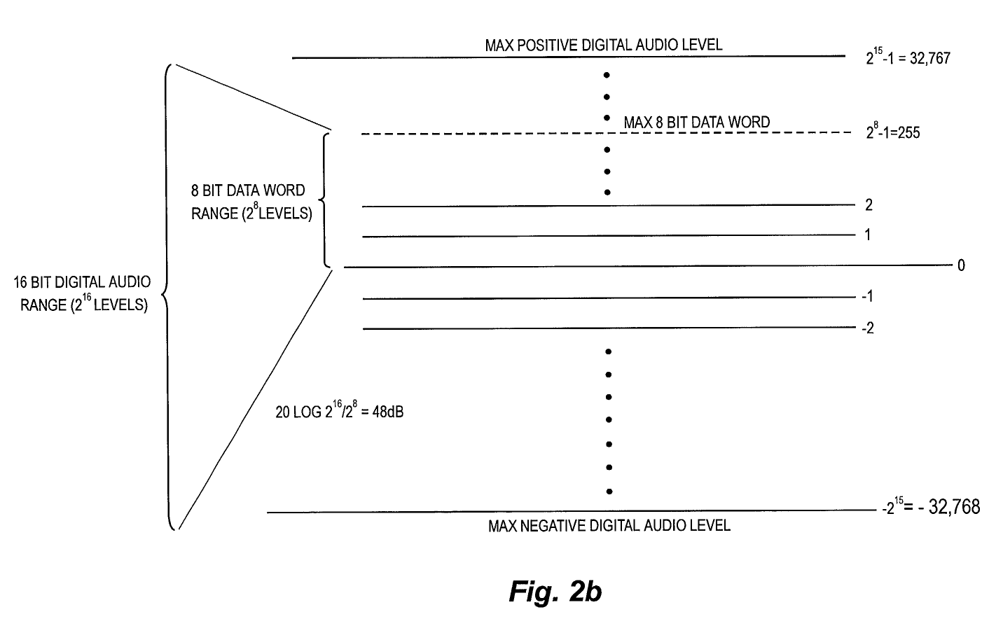

FIGS. 2a and 2b illustrate the encoding of non-audio data according to the preferred embodiment. In FIG. 2a, the non-audio data is encoded as the non-audio data track using only the first 8 bits of the 16 bit data word. An audio signal resulting from such a non-audio data track has a range of discrete amplitudes ranging from 0 to +255, resulting in a peak audio level that is 48 dB less than the peak audio level available using the Red Book standard. FIG. 2b illustrates a comparison of the non-audio data track's peak audio level, when the non-audio data is encoded using only 8 bits, and the peak audio level using all 16 bits available under the Red Book standard. One possible way to obtain a non-audio data track which only uses the first 8 bits of the 16 bit data word is to restrict the non-audio data to a character set which uses only 8 bits to represent the characters in the set. Such character sets are well known to those skilled in the art. In alternative embodiments, the non-audio data may be encoded using the first 7 bits plus the sign bit, thus also using 8 bits of the 16 bit data word.

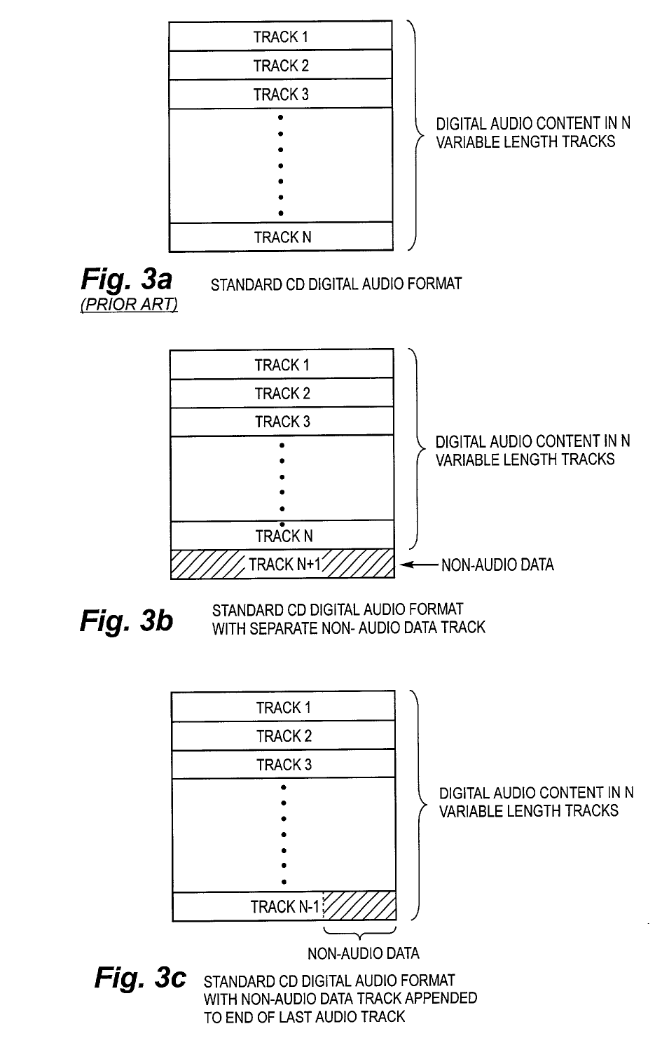

Once the non-audio data is encoded as the non-audio data track as described above, the non-audio data track may be recorded onto the CD medium along with the plurality of digital audio tracks. FIG. 1c illustrates a CD medium 100 onto which the digital audio and non-audio data tracks may be recorded. The compact disc 100 has three tracks 102, 104, 106 on which the digital audio and non-audio data tracks are recorded. FIG. 3a illustrates the prior art in which N variable length digital audio tracks are recorded onto a CD using the Red Book standard. FIG. 3b illustrates the preferred embodiment in which the non-audio data track is recorded as the last track, the N+1 track, on a CD containing N variable length digital audio tracks. Referring to FIG. 1c, the last track 106 on the CD 100 is the non-audio data track and two digital audio tracks are recorded as the first and second tracks 102, 104. CDs having tracks recorded according to the method described herein, such as the CD 100 illustrated in FIG. 3a, are fully compatible with current CD players because the non-audio data track has an audio format and all the tracks are recorded on the CD according to the Red Book standard. Current CD players, however, would not gain any benefit or functionality from the encoded non-audio data.

Alternatively, the non-audio data track may be incorporated into one digital audio track selected from the plurality of digital audio tracks to be recorded onto the CD 100. The non-audio data track may be incorporated at either the beginning or the end of the one digital audio track. Under such circumstances, the non-audio data track acts as an extension of the one digital audio track and is not recorded as a separate track on the CD. FIG. 3c illustrates an embodiment in which the non-audio data track is incorporated at the end of the one digital audio track. The one digital audio track is then recorded as the last track, track N, on a CD of N variable length tracks. The one digital audio track is preferably the last track on the CD to avoid having the audio signal from the non-audio data track play between tracks. Likewise, where the non-audio data track is incorporated at the beginning of the one digital audio track at, the one digital audio track is preferably the first track on the CD. Compatibility with current CD players is also preserved using these alternative methods of recording the non-audio data track on the CD.

FIG. 1d illustrates a layout of hardware that may be used for retrieving the non-audio data encoded on the non-audio data track and recorded on the CD 100. The CD 100 is placed in a CD player 108. The CD player 108 may be a stand alone component unit or may be incorporated into a personal computer. Read electronics 110, which may or may not be integral to the CD player 108, control the operation in cooperation with the controller 118. The controller 118 and its peripheral components 120 perform conventional tasks which are well known to those skilled in the art. A memory 112 illustrates the cache memory of the CD player 112 or the RAM of a personal computer. The memory caches information needed for interpreting CD tracks according to the various standards that may be used to record tracks on a CD. For example, the memory in FIG. 1d comprises a Red Book cache 114 for interpreting CD tracks recorded according to the Red Book standard and a Yellow book cache 116 for interpreting CD tracks recorded according to the Yellow Book standard.

The audio signal resulting from the encoded non-audio data, as described above, would likely be very repetitive, have distinct pitch and tone qualities, and quite likely very noticeable to a listener. Therefore, in the preferred embodiment, the non-audio data track is encoded such that the audio signal is substantially equally distributed across an audio spectrum, thereby reducing any potential disruption to a listener caused by the nature of the audio signal. The preferred audio spectrum is based on human auditory responsiveness and ranges from approximately 20 Hz to 20 kHz. By substantially equally distributing the audio signal across the audible spectrum, the audio signal resembles white noise when heard during playback of the CD. This approximation of white noise is used in the preferred embodiment to make the audio signal as unobtrusive and unnoticeable to a listener as possible. The audio signal is even less obtrusive and noticeable because the non-audio data track is encoded using a number of bits that is less than the full 16 bit data word provided by the Red Book standard.

Other audio spectrum may also be chosen, as the method of encoding non-audio data is not limited by the particular audio spectrum used. However, the audio frequency limitations of the CD players intended to read the non-audio data track may serve to effectively limit the choice of audio spectrum.

One method that may be used to achieve a desired audio spectrum is by combining the non-audio data with a 16 bit pseudo random sequence to form a data sequence. The data sequence thus created is encoded as the non-audio data track using the method described above. By carefully choosing or creating a pseudo random sequence, any audio spectrum may be achieved, even one that is non-contiguous. In the preferred embodiment, the approximation of white noise is created using this method.

The process of combining the non-audio data with the pseudo random sequence may be performed in any manner which suitably disguises the non-audio data and satisfies the goal of making it as unobtrusive and unnoticeable as possible. Any process used in encoding the non-audio data, however, must be reversible so that the non-audio data may be properly decoded by a CD player. In the preferred embodiment, the data sequence is formed by using a stream cipher to perform an exclusive OR (XOR) operation on the non-audio data and the pseudo random sequence. The stream cipher may generate the pseudo random sequence using one of the many types of pseudo random sequence generators known to those skilled in the art.

The XOR operation preserves both the non-audio data for later decoding and the pseudo random nature of the pseudo random sequence. The non-audio data may be easily recovered by a CD player or computer by performing an XOR operation using the pseudo random sequence and the non-audio data track as read from the CD. Those skilled in the art will recognize that CD players and computers need access to the pseudo random sequence in order to properly to recover the non-audio data. Therefore, for any commercial embodiment of the invention, the logistics of ensuring that CD players and computers have access to the pseudo random sequence for the decoding process should be taken into account when choosing the method of generating the sequence. However, such logistics do not present any restrictions on the actual pseudo random sequence used for the purposes of this invention.

In the preferred embodiment, the non-audio data comprises a first set of data and a second set of data. The first data is encoded using the method described above. Unfortunately, the first data may be and frequently is lost when the tracks on the CD are resampled. Resampling is the process of converting a digital audio signal to an analog signal (the “sampling” step) and then converting the analog signal back to a digital signal (the “resampling” step). Two separate clocks and conversion circuitry are frequently used for each conversion step in this process. The resampling process may cause any signal encoded in the audio to be degraded due to imperfections in the converters, frequency response errors, or noise in the circuitry. Additionally, the resampling circuitry may use a clock signal that is not exactly equal in frequency or does not have the same phase as the clock signal used by the sampling circuitry. Where the resampling clock signal varies from the sampling clock signal, the resampling process may make it impossible to retrieve the original digitally encoded non-audio data.

In the preferred embodiment, the second data is encoded as a watermark within the non-audio data track because non-audio data encoded in a watermark is not easily lost to the resampling process. By placing the second data in a watermark, at least a portion of the encoded non-audio data is preserved following the resampling process. The methods and techniques used to encode watermarks in audio tracks, i.e., superimposing a small amount of data over the audio on a CD, are well known to those skilled in the art. Due to the limitations of the watermarking process, data in a watermark is necessarily limited in scope and frequently contains only identifying information for the CD. Since the non-audio data track is essentially nothing more than non-audio data masquerading as an audio track, these well known methods and techniques may also be used to place a watermark in the non-audio data track. One method of placing a watermark, for example, is to encode the second data as an array of narrow frequency bands and superimpose the bands on the non-audio data track. The bands preferably comprise low level audio signals at selected frequencies that are less audible to humans. The information in the narrow bands therefore serves as an indication of the presence or absence of the first data encoded in the non-audio data track.

One potential application for the above described encoding process, wherein non-audio data comprises first data and second data, the first data is encoded and recorded on a CD as a non-audio data track, and the second data is encoded as a watermark in the non-audio data track, is in allowing the owners of intellectual property rights to prevent the unwanted copying or recording of the digital audio stored on CD's. In furtherance of copy protecting CD's, the first data may be encrypted or not as desired and encoded as the non-audio data track as part of a copy protection scheme. The second data is encoded as a watermark in the non-audio data track to indicate the presence of the copy protection scheme. A CD player or computer designed to check the copy protection data, i.e., the first data, prior to allowing the tracks to be copied will not copy or record the digital audio without being able to decode and verify the first data. If a copy is made through a resampling process and the first data is lost, then a CD player or computer will detect the presence of a copy protection scheme the CD through the presence of the watermark. Following the detection of the watermark and the inability to decode the first data lost to resampling, a CD player or computer so designed will be incapable of copying or recording the digital audio on the CD.

The method described herein provides several significant advantages when compared with prior attempts to store non-audio data together with digital audio on CDs. For example, the method described herein does not interfere with the normal playback of audio because it does not interleave the non-audio data with the digital audio data in any way. By comparison, storing the non-audio data using the “watermarking” technique creates noise by superimposing the non-audio data over the digital audio data. Another advantage of the method described herein lies in its efficiency. Unlike methods that require a gap between the audio and data sectors of the disc, such as the method used to create Multisession CD, non-audio data encoded as audio presents no significant fixed overhead. None of the disc capacity is lost through the need to separate the non-audio data from the digital audio data. Yet another significant advantage lies in the flexibility of the method described herein, as it may used with any type of non-audio data, thus making it adaptable to future needs in encoding and recording non-audio data on a digital audio CD.

Thus, a method for encoding and recording non-audio data on a compact disc medium is disclosed. While embodiments of this invention have been shown and described, it would be apparent to those skilled in the art that many more modifications are possible without departing from the inventive concepts herein. The invention, therefore, is not to be restricted except in the spirit of the appended claims.

What is claimed is:

1. A method for encoding and recording non-audio data on a compact disc medium comprising the steps of:
encoding the non-audio data as a non-audio data track having an audio format compatible with a standard format, wherein the standard format calls for digital audio encoding utilizing a predefined number of bits per sample and the non-audio data is encoded using less than the predefined number of bits per sample; and
recording a plurality of digital audio tracks and the non-audio data track on the compact disc medium in accordance with the standard format.

2. The method of claim 1, wherein the non-audio data comprises encrypted data.

3. The method of claim 1, wherein the non-audio data is encoded using no more than one-half the predefined number of bits per sample.

4. The method of claim 1, wherein the non-audio data track represents an audio signal that is shaped to a particular audio spectrum.

5. The method of claim 4, wherein the audio signal is substantially equally distributed across the audio spectrum.

6. The method of claim 4, wherein the audio spectrum ranges from 20 Hz to 20 kHz.

7. The method of claim 1, wherein the step of encoding the non-audio data comprises:
combining the non-audio data with a pseudo random sequence to generate a data sequence; and
encoding the data sequence as the non-audio data track using less than the predefined number of bits per sample.

8. The method of claim 1, wherein the non-audio data track is recorded as the last track on the compact disc medium.

9. The method of claim 1, wherein, prior to the recording step, the method further comprises the step of incorporating the non-audio data track into one digital audio track selected from the plurality of digital audio tracks.

10. The method of claim 9, wherein the non-audio data track is incorporated at the end of the one digital audio track.

11. The method of claim 9, wherein the non-audio data track is incorporated at the beginning of the one digital audio track.

12. The method of claim 1, wherein the standard format is in accordance with a Red Book standard.

13. A method for encoding and recording non-audio data on a compact disc medium comprising the steps of:
combining the non-audio data with a pseudo random sequence to obtain a data sequence;
encoding the data sequence as a non-audio data track having an audio format compatible with a standard format calling for digital audio encoding utilizing a predefined number of bits per sample; and recording a plurality of digital audio tracks and the non-audio data track on the compact disc medium in accordance with the standard format.

14. The method of claim 13, wherein the non-audio data comprises encrypted data.

15. The method of claim 13, wherein the data sequence is encoded using less than the predefined number of bits per sample.

16. The method of claim 13, wherein the non-audio data is encoded using no more than one-half the predefined number of bits per sample.

17. The method of claim 13, wherein the non-audio data track represents an audio signal that is shaped to a particular audio spectrum.

18. The method of claim 17, wherein the audio signal is substantially equally distributed across the audio spectrum.

19. The method of claim 17, wherein the audio spectrum ranges from 20 Hz to 20 kHz.

20. The method of claim 13, wherein the non-audio data track is recorded as the last track on the compact disc medium.

21. The method of claim 13, wherein, prior to the recording step, the method further comprises the step of incorporating the non-audio data track into one digital audio track selected from the plurality of digital audio tracks.

22. The method of claim 21, wherein the non-audio data track is incorporated at the end of the one digital audio track.

23. The method of claim 21, wherein the non-audio data track is incorporated at the beginning of the one digital audio track.

24. The method of claim 13, wherein the standard format is in accordance with a Red Book standard.

25. A method for encoding and recording non-audio data on a compact disc medium, wherein the non-audio data comprises first data and second data, the method comprising the steps of:
combining the first data with a pseudo random sequence to obtain a data sequence;
encoding the data sequence as a non-audio data track having an audio format compatible with a standard format calling for digital audio encoding utilizing a predefined number of bits per sample;
encoding the second data as a watermark within the non-audio data track; and
recording a plurality of digital audio tracks and the non-audio data track on the compact disc medium in accordance with the standard format.

26. The method of claim 25, wherein the first data comprises encrypted data.

27. The method of claim 25, wherein the data sequence is encoded using less than the predefined number of bits per sample.

28. The method of claim 25, wherein the non-audio data is encoded using no more than one-half the predefined number of bits per sample.

29. The method of claim 25, wherein the non-audio data track represents an audio signal that is shaped to a particular audio spectrum.

30. The method of claim 29, wherein the audio signal is substantially equally distributed across the audio spectrum.

31. The method of claim 29, wherein the audio spectrum ranges from 20 Hz to 20 kHz.

32. The method of claim 25, wherein the non-audio data track is recorded as the last track on the compact disc medium.

33. The method of claim 25, wherein, prior to the recording step, the method further comprises the step of incorporating the non-audio data track into one digital audio track selected from the plurality of digital audio tracks.

34. The method of claim 33, wherein the non-audio data track is incorporated at the end of the one digital audio track.

35. The method of claim 33, wherein the non-audio data track is incorporated at the beginning of the one digital audio track.

36. The method of claim 25, wherein the standard format is in accordance with a Red Book standard.

37. A method for encoding and recording non-audio data on a compact disc medium, wherein the non-audio data comprises first data and second data, the method comprising the steps of:
combining the first data with a pseudo random sequence to obtain a data sequence;
encoding the data sequence as a non-audio data track having an audio format compatible with a standard format, wherein the standard format calls for digital audio encoding utilizing a predefined number of bits per sample and the data sequence is encoded using less than the predefined number of bits per sample;
encoding the second data as a watermark within the non-audio data track;
incorporating the non-audio data track into one digital audio track selected from a plurality of digital audio tracks; and
recording the plurality of digital audio tracks and the non-audio data track on the compact disc medium in accordance with the standard format.

38. The method of claim 37, wherein the first data comprises encrypted data.

39. The method of claim 37, wherein the non-audio data is encoded using no more than one-half the predefined number of bits per sample.

40. The method of claim 37, wherein the non-audio data track represents an audio signal that is shaped to a particular audio spectrum.

41. The method of claim 40, wherein the audio signal is substantially equally distributed across the audio spectrum.

42. The method of claim 40, wherein the audio spectrum ranges from 20 Hz to 20 kHz.

43. The method of claim 37, wherein the standard format is in accordance with a Red Book standard.

44. The method of claim 37, wherein the non-audio data track is incorporated at the end of the one digital audio track.

45. The method of claim 37, wherein the non-audio data track is incorporated at the beginning of the one digital audio track.
